(19) United States
(12) Patent Application Publication
(10) Pub. No.: US 2008/0244738 A1
(43) Pub. Date: Oct. 2, 2008

(54) ACCESS CONTROL

(75) Inventors: Kensuke Shiozawa, Kawasaki (JP); Yoshitake Shinkai, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/057,069

(22) Filed: Mar. 27, 2008

(30) Foreign Application Priority Data
Mar. 28, 2007 (JP) 2007-085786
Feb. 6, 2008 (JP) 2008-026897
Mar. 27, 2008 (JP) 2008-083565

(51) Int. Cl. G06F 12/14

(52) U.S. Cl. 726/21

(57) ABSTRACT

An access control method includes receiving an access request to a file system from a user terminal through a common Internet file system (CIFS) or a network file system (NFS) and determining whether the access request should be allowed. The method includes determining whether a basic permission attribute of an access request used in the NFS should be allowed with reference to access control information associated with basic permission attributes, the basic permission attribute being associated with an access request received from the user terminal through the CIFS, the access control information indicating whether an access request to respective objects of the file system should be allowed or denied, and the access control information being stored in an access-control-information storing unit. The method also includes determining whether the access request associated with the allowed basic permission attribute should be allowed, in reference to the access control information.

### CROSS-REFERENCE TO RELATED APPLICATIONS

This application is based upon and claims the benefit of priority from Japanese Patent Applications No. 2007-085786, filed Mar. 28, 2007; No. 2008-026897, filed Feb. 6, 2008; and No. 2008-083565, filed Mar. 27, 2008, the entire contents of which are incorporated herein by reference.

### BACKGROUND OF THE INVENTION

1. Field of the Invention

The present invention relates to access control that, in response to a request for access to a file system from the user terminal through a common Internet file system (CIFS) or a network file system (NFS), determines whether the access request should be allowed.

2. Description of the Related Art

Conventionally, in the information society in which enormous electronic data are produced, file servers such as network attached storages (NAS) for sharing such electronic data among a variety of clients are important as a technology.

As file access protocols used by the variety of clients to access the NAS, NFS for UNIX (registered trademark) clients and CIFS for Windows (registered trademark) clients are two kinds of file access protocols mainly used.

When a file server is implemented for an environment in which both of clients that use the NFS and clients that use the CIFS are present, available content of access permission (access control) is different depending on a protocol. Therefore, it is necessary to introduce separate file servers corresponding to the respective protocols. This leads to an increase in cost. To reduce cost, various technologies for developing a file server that is applicable to both the NFS and the CIFS have been disclosed.

For example, U.S. Pat. No. 6,457,130 discloses a technology for developing a new file server regardless of software asset such as a UNIX (registered trademark) server and a Windows (registered trademark) server in the past. In the disclosed technology, correct access control for clients that use the CIFS is carried out.

As a technology employing Samba that is general public license (GPL) software, there is a technology for developing a file server applicable to the CIFS using a UNIX (registered trademark) operating system (OS) applicable to only the NFS (see “Samba 2.2 Details—Comparison of function with Windows NT/2000”, Samba Users Group Japan, [online], [retrieved on Feb. 21, 2007], Internet <http://www1.samba.gr.jp/doc/func_{—}2.2.html> (hereinafter, “Non-Patent Document 1”)). Specifically, Samba carries out access control for both the clients that use the NFS and the clients that use the CIFS, based on the basic permission attributes, “read permission”, “write permission”, and “execution permission” inherent in the standard UNIX (registered trademark) or portable operating system interface for UNIX-access control list (POSIX-ACL).

However, in the technology disclosed in U.S. Pat. No. 6,457,130, extremely many manhours are required to develop a file server. Specifically, it is necessary to develop functions and access control of both of the existing UNIX (registered trademark) server and Windows (registered trademark) server in one file server. Therefore, extremely many manhours are required to develop the server.

In the technology disclosed in Samba, accurate access control cannot be performed. Specifically, access permissions of Windows (registered trademark) system s using the CIFS include detailed permissions such as “permission to change attributes and permission to create a subdirectory” in addition to the basic permission attributes “read permission”, “write permission”, and “execution permission” inherent in the standard UNIX (registered trademark) or POSIX-ACL. Therefore, in Non-Patent Document 1, access control of the CIFS (Windows (registered trademark)) having these detailed permissions is associated with access permissions of the NFS (UNIX (registered trademark)) having only the basic permission attributes to realize access control. Therefore, the technology lacks accuracy and cannot accurately control the access permissions of Windows (registered trademark).

### SUMMARY OF THE INVENTION

It is an object of the present invention to at least partially solve the problems in the conventional technology.

According to an aspect of the present invention, a computer program product has a computer readable medium including programmed instructions for receiving an access request to a file system from a user terminal through a common Internet file system (CIFS) or a network file system (NFS) and for determining whether the access request should be allowed. The instructions, when executed by a computer, cause the computer to perform determining whether a basic permission attribute of an access request used in the NFS should be allowed with reference to access control information associated with basic permission attributes, the basic permission attribute being associated with an access request received from the user terminal through the CIFS, the access control information indicating whether an access request to respective objects of the file system should be allowed or denied, and the access control information being stored in an access-control-information storing unit; and determining whether the access request associated with the allowed basic permission attribute should be allowed, in reference to the access control information stored in the access-control-information storing unit.

According to another aspect of the present invention, an access control apparatus, connected to a user terminal by a common Internet file system (CIFS) or a network file system (NFS), receives a request for access to a file system from the user terminal, and determines whether the access request should be allowed. The access control apparatus includes an access-control-information storing unit that stores therein access control information indicating whether an access request to respective objects of the file system should be allowed or denied; a first access control unit that determines whether a basic permission attribute of an access request used in the NFS should be allowed with reference to the access control information which is associated with basic permission attributes and is stored in the access-control-information storing unit, the basic permission attribute being associated with an access request received from the user terminal through the CIFS; and a second access control unit that determines whether the access request associated with the allowed basic permission attribute should be allowed, in reference to the access control information stored in the access-control-information storing unit.

According to still another aspect of the present invention, an access control method is for receiving an access request to a file system from a user terminal through a common Internet file system (CIFS) or a network file system (NFS) and for determining whether the access request should be allowed. The access control method includes determining whether a basic permission attribute of an access request used in the NFS should be allowed with reference to access control information associated with basic permission attributes, the basic permission attribute being associated with an access request received from the user terminal through the CIFS, the access control information indicating whether an access request to respective objects of the file system should be allowed or denied, and the access control information being stored in an access-control-information storing unit; and determining whether the access request associated with the allowed basic permission attribute should be allowed, in reference to the access control information stored in the access-control-information storing unit.

According to still another aspect of the present invention, a computer program product has a computer readable medium including programmed instructions for receiving an access request to a file system from a user terminal through a common Internet file system (CIFS) or a network file system (NFS) and for determining whether the access request should be allowed. The instructions, when executed by a computer, cause the computer to perform issuing, when a file creation request is received from a user terminal through the CIFS, before issuing a system call for performing file creation in response to the file creation request, access control information for the file indicating whether an access request is allowed concerning respective objects of the file system through an I/O control different from the system call; executing storing processing for storing access control information issued through the I/O control in an extended attribute area of an inode on the file system in each of sessions of journals identical with respective journals for respective kinds of metadata update processing carried out in the file system; and determining, when an access request is received from the user terminal through the CIFS, whether the access request is allowed, based on the access control information stored in the file system.

According to still another aspect of the present invention, an access control apparatus, connected to a user terminal through a common Internet file system (CIFS) or a network file system (NFS), receives an access request to a file system from the user terminal and determines whether the access request should be allowed. The access control apparatus includes an access-control-information issuing unit that issues, when a file creation request is received from the user terminal connected through the CIFS, before issuing a system call for performing file creation in response to the file creation request, access control information for the directory indicating whether an access request is allowed concerning respective objects of the file system to an I/O control different from the system call and issues the access control information; a storing processing unit that executes storing processing for storing the access control information issued through the I/O control by the access-control-information issuing unit in an extended attribute area of an inode on the file system in each of sessions of journals identical with respective journals for respective kinds of metadata update processing carried out in the file system; and an access control unit that determines, when the access request is received from the user terminal connected by the CIFS, based on the access control information stored in the file system by the storing processing unit, whether the access request is allowed.

According to still another aspect of the present invention, an access control method is for receiving an access request to a file system from a user terminal through a common Internet file system (CIFS) or a network file system (NFS) and for determining whether the access request should be allowed. The access control method includes issuing, when a file creation request is received from the user terminal through the CIFS, before issuing a system call for performing file creation in response to the file creation request, access control information for the directory indicating whether an access request is allowed concerning respective objects of the file system to an I/O control different from the system call, and issuing the access control information; executing storing processing for storing the access control information issued through the I/O control in an extended attribute area of an inode on the file system in each of sessions of journals identical with respective journals for respective kinds of metadata update processing carried out in the file system; and determining, when the access request is received from the user terminal through the CIFS, based on the access control information stored in the file system by the storing processing unit, whether the access request is allowed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram of an overall configuration of a system including a file server according to a first embodiment of the present invention;

FIG. 2 is a diagram for explaining the file server according to the first embodiment;

FIG. 3 is a block diagram of the structure of the file server according to the first embodiment;

FIG. 4 is a diagram of an example of information stored in an access control information DB;

FIG. 5 is a flowchart of a flow of access request determination processing in the file server according to the first embodiment;

FIG. 6 is a sequence chart of a flow of the access request determination processing in the file server according to the first embodiment;

FIG. 7 is a flowchart of a flow of an access evaluation rule;

FIG. 8 is a diagram of an example of storage of access control information in an extended area;

FIG. 9 is a diagram of an example of a table in which access requests and basic permission attributes are associated;

FIG. 10 is a block diagram of the structure of a file server according to a second embodiment of the present invention;

FIG. 11 is a diagram for explaining hook control for a file system interface (FSIF);

FIG. 12 is a conceptual diagram of an fshook_task structure;

FIG. 13 is a sequence chart of a flow of processing of the file server according to the second embodiment;

FIG. 14 is a flowchart of a flow of ACL inheritance processing of the file server according to the second embodiment;

FIG. 15 is a flowchart of a flow of NT-ACL evaluation processing of the file server according to the second embodiment; and

FIG. 16 is a diagram of an example of a computer system that executes an access control program.

### DETAILED DESCRIPTION OF THE PREFERRED EMBODIMENTS

Exemplary embodiments of the present invention are explained in detail below.

A file server in a first embodiment of the present invention is a computer that shares a database and the like managed by the file server with other computers on networks such as a local area network (LAN) and a wide area network (WAN) and makes it possible to use the database from the outside. For example, a network attached storage (NAS) corresponds to the file server. The file server executes an access control program.

When files are arranged on the file server, a computer connected to the file server can freely perform operation for viewing and updating the files. This makes it possible to eliminate complicated work such as movement and update management of the files performed among computers in the past and makes it remarkably easy to manage data (the files).

User terminals that use the file server include a terminal that makes connection to the file server using a Windows (registered trademark) common Internet file system (CIFS) and a terminal that makes connection to the file server using a UNIX (registered trademark) network file system (NFS). The CIFS and the NFS are protocols for using the file server. Access permissions that can be designated by these protocols are different. Specifically, when the CIFS is used, more detailed access permissions can be designated compared with access permissions that can be designated when the NFS is used.

Therefore, to use the file server in an environment in which these protocols are mixed, accesses from both the clients are controlled by mapping the access permission of the NFS onto the access permission of the CIFS. However, when the access permission of the NFS is mapped onto the access permission of the CIFS, the detailed access permission of the CIFS is forcibly controlled by the access permission of the NFS and cannot be accurately controlled. Specifically, the file server needs to map the access permission of the CIFS onto three basic permission attributes, “READ”, “WRITE”, and “EXEC” of the NFS and control the access permission of the NFS.

Consequently, an access request that should be denied in the CIFS is allowed in the NFS. Therefore, there is an earnest desire for a file server that can accurately control both of the access permission of the NFS and the access permission of the CIFS when the file server is used in the environment in which these protocols are mixed. In this embodiment, a directory creation request is explained as an example of a file creation request. However, the present invention is not limited to this. For example, this embodiment can be also applied to requests for creation of files such as a device file and a SOCKET file. Besides the file creation requests, the embodiment can also be applied to a general UNIX system call.

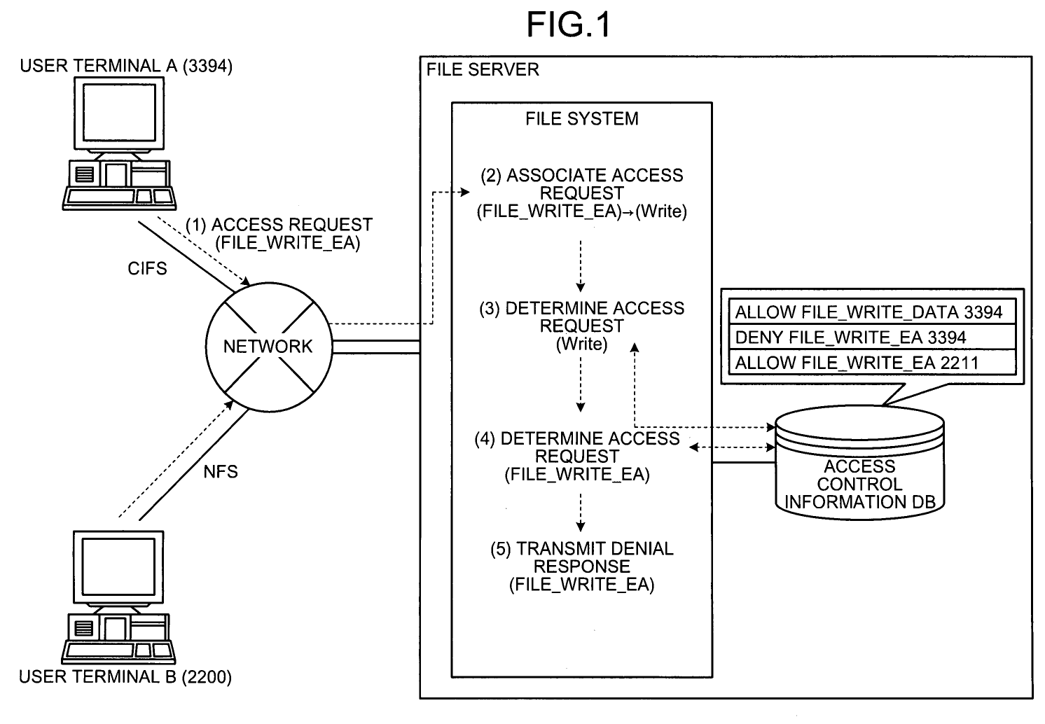

An outline and feature of the file server according to the first embodiment will be described below in reference to FIG. 1.

In this system, as described above, a user terminal A with a user ID “3394”, a user terminal B with a user ID “2200”, and the file server are connected to be capable of communicating with one another through a network. The user terminal A and the file server are connected by the CIFS. The user terminal B and the file server are connected by the NFS.

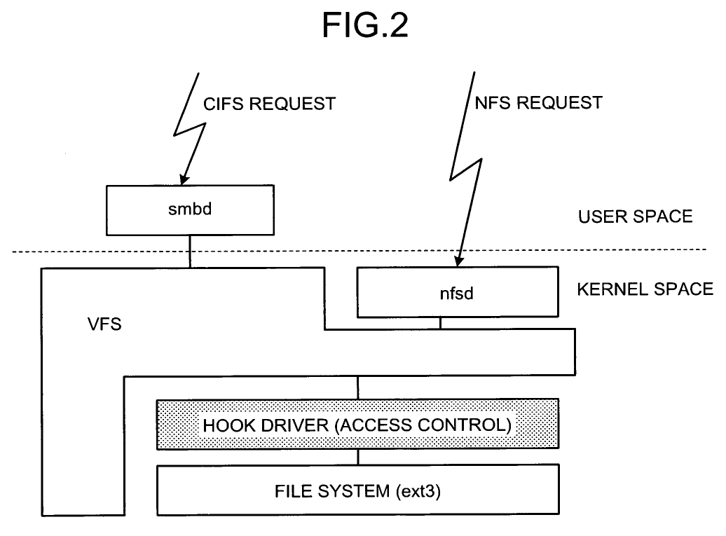

As shown in FIG. 2, the file server starts a virtual file system (VFS) that allows the user terminals to use a file system as an access request destination from various applications. The file server further starts an smbd that is a program of Samba as a program (daemon) for receiving an access request through the CIFS. Similarly, the file server starts an nfsd for receiving an access request through the NFS. The file server stores access control information used in an UNIX (registered trademark) operating system (OS). The access control is a hook driver that intervenes between the VFS and an ext3 to carry out NT-ACL control (access control).

In such a configuration, as described above, the file server is connected to the user terminals by the CIFS or the NFS, receives requests for access to the file system from the user terminals. The file server further determines whether the access request should be allowed using access control of the file server itself, instead of the file system. As a main feature of this embodiment, it is possible to establish, with manhours fewer than those in the technology in the past, a file server that can perform accurate access control.

Specifically, the file server stores, in an access control information database (DB), access control information that indicates whether access to respective objects of the file system should be allowed. As a specific example, the file server stores “ALLOW FILE_WRITE_DATA 3394”, “DENY FILE_WRITE_EA 3394”, “ALLOW FILE_WRITE_EA 2211”, and the like in the access control information DB as access control information. “ALLOW FILE_WRITE_DATA 3394” indicates that writing of data “FILE_WRITE_FILE” from a user terminal with a user ID “3394” is allowed. “DENY FILE_EA 3394” indicates that writing of an extended attribute “FILE_WRITE_EA” from the user terminal with the user ID “3394” is denied. “ALLOW FILE_WRITE_EA 2211” indicates that writing of an extended attribute “FILE_WRITE_EA” from a user terminal with a user ID “2211” is allowed.

In such a state, when an access request is received from the user terminal connected by the CIFS, the file server associates the access request with any one of read permission, write permission, and execute permission that are the basic permission attributes of an access request used in the NFS (see (1) and (2) in FIG. 1). Specifically, in the example explained above, the file server receives an access request “SETPATHINF0” from the user terminal A connected by the CIFS. Then, the file server associates the permission “FILE_WRITE_EA”, which corresponds to the access request and which is “writing of an extended attribute”, with write permission “Write” among the read, write, and execute permissions that are the basic permission attributes of the access request used in the NFS.

Then, the file server associates the basic permission attribute with the respective pieces of access control information stored in the access control information DB. When the associated basic permission attribute is allowed concerning at least one of the items of access control information associated with the basic permission attribute, the file server determines to allow the basic permission attribute. When the associated basic permission attribute is denied concerning all the items of access control information, the file server determines to deny the basic permission attribute (see (3) in FIG. 1). Specifically, in the example described above, when the permission “FILE_WRITE_EA” of the access request “SETPATHINF0” is associated with the basic permission attribute “Write”, the file server associates the basic permission attribute with the respective pieces of access control information stored in the access control information DB. For example, the file server associates “ALLOW FILE_WRITE_DATA 3394” stored in the access control information DB with “ALLOW Write” or associates “DENY FILE_WRITE_EA 394” stored in the access control information DB with “DENY Write”.

The file server determines whether the associated basic permission attribute “Write” is allowed concerning at least one of the items of access control information associated with the basic permission attribute “Write” or is denied concerning all the items of access control information. The file server refers to the access control information in order from a first piece. Because “ALLOW Write (ALLOW FILE_WRITE_DATA 3394)” is stored, the file server determines that the associated basic permission attribute “Write” is allowed.

The file server determines, referring to the access control information stored in the access control information DB, whether the access request associated with the allowed basic permission attribute should be allowed (see (4) in FIG. 1). Specifically, in the example described above, the file server refers to the access control information stored in the access control information DB with respect to the permission “FILE_WRITE_EA” of the access request “SETPATHINF0 COMMAND” associated with the allowed basic permission attribute “Write”. Because “DENY FILE_WRITE_EA 3394” is included in the access control information, the file server denies the permission “FILE_WRITE_EA”. The file server transmits a denial response indicating that the access request is denied to the user terminal A (see (5) in FIG. 1).

In this way, like the main feature described above, the file server according to the first embodiment can be developed to perform accurate access control, with manhours fewer than those in the technology in the past.

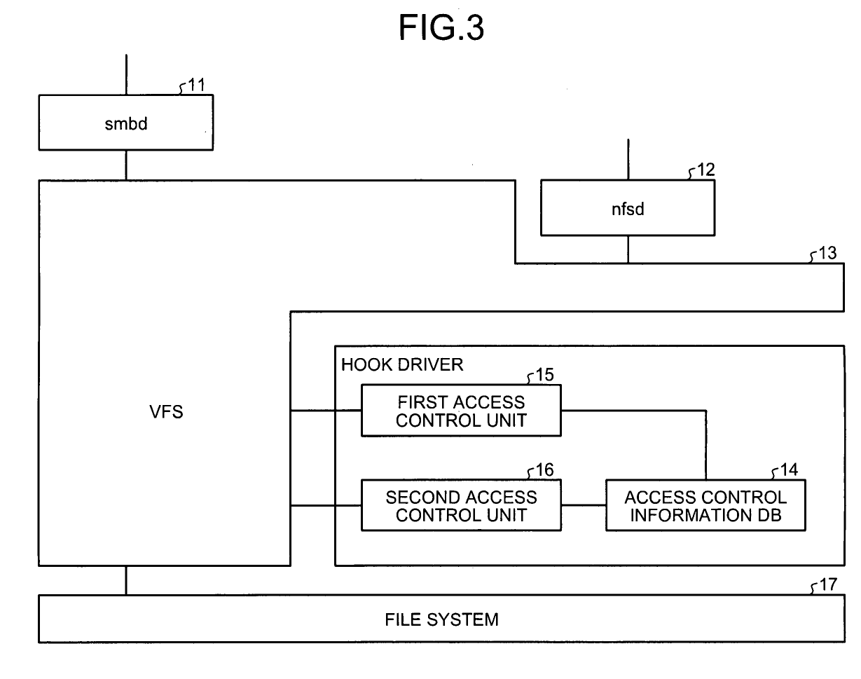

A configuration of the file server according to the first embodiment will be described below with reference to FIG. 3. As shown in FIG. 3, the file server includes an smbd 11; an nfsd 12; a VFS 13; a hook driver which includes an access control information DB 14, a first access control unit 15, and a second access control unit 16; and a file system 17.

When an access request is received from a user terminal connected by the CIFS, the smbd 11 associates the access request with any one of the read, write, and execute permissions that are the basic permission attributes of the access request used in the NFS. Specifically, in the example described above, the smbd 11 receives the access request “SETPATHINF0” from the user terminal A connected by the CIFS. In response, the smbd 11 interprets the access request as “writing of an extended attribute” and then requests the VFS 13 it.

When an access request is received from a user terminal connected by the NFS, the nfsd 12 outputs the access request to the VFS 13 described later. Specifically, when an access request “mkdir” is received from the user terminal connected by the NFS, the nfsd 12 outputs the access request to the VFS 13.

The VFS 13 is an abstraction layer located above the file system 17 and allows a user terminal to access the file system using various applications. Specifically, in the example described above, when the associated “Write” is received from the smbd 11, the VFS 13 associates “writing of an extended attribute” received from the smbd 11 with one of the basic permission attributes of the access request used in the NFS, “read permission”, “write permission”, and “execution permission”, and instructs the first access control unit 15 described later to determine accessibility of the basic permission attribute “Write”. The VFS 13 receives a result of execution by the second access control unit 16 described later and transmits the result to the user terminal.

For example, when “mkdir” is executed by the second access control unit 16, the VFS 13 transmits an indication that a file is created to the user terminal. When the access request received from the user terminal is denied by the second access control unit 16, the VFS 13 transmits a response indicating denial to the user terminal.

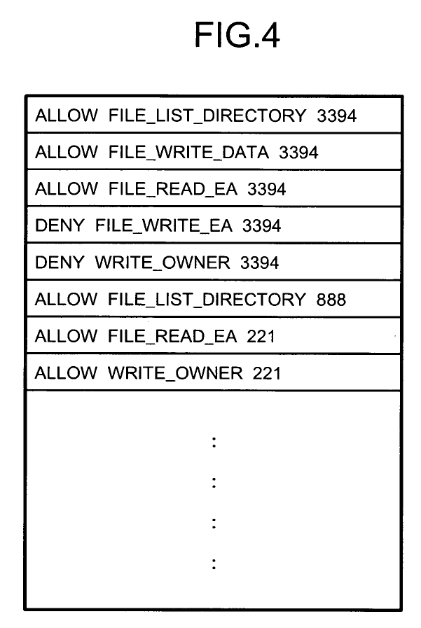

The access control information DB 14 stores access control information indicating whether access to respective objects of the file system 17 is allowed or denied. Specifically, in the example described above, as shown in FIG. 4, the access control information DB 14 stores “ALLOW FILE_LIST_DIRECTORY 3394”, “ALLOW FILE_READ_EA 3394”, “DENY WRITE_OVER 3394”, and the like. “ALLOW FILE_LIST_DIRECTORY 3394” indicates that reference to a file list in a directory “FILE_LIST_DIRECTORY” from the user terminal with the user ID “3394” is allowed. “ALLOW FILE_READ_EA 3394” indicates that readout of an extended attribute of the user terminal with the user ID “3394” is allowed. “DENY WRITE_OWNER 3394” indicates that becoming an owner of a file currently operated by the user terminal with the user ID “3394” “WRITE_OWNER” is denied.

Each of the pieces of stored information such as “ALLOW FILE_READ_EA 3394” is referred to as access control entry (ACE). The information including various data and parameters described above can be arbitrarily changed unless specifically noted otherwise. The access control information DB 14 may be referred to as an access-control-information storing unit.

The first access control unit 15 determines whether the associated basic permission attribute “Write” is allowed concerning at least one of the associated items of access control information or is denied concerning all of the items of access control information. Specifically, in the example described above, the first access control unit 15 receives a determination instruction from the VFS 13, determines whether the associated basic permission attribute “Write” is allowed concerning at least one of the items of access control information stored in the access control information DB associated with the basic permission attribute “Write” or is denied concerning all of the items of access control information. The first access control unit 15 outputs a result of the determination to the VFS 13. The file server refers to the access control information in order from a first piece. Because “ALLOW FILE_WRITE_DATA 3394” is stored, the file server determines that the associated basic permission attribute “Write” is allowed.

The second access control unit 16 refers to the access control information stored in the access control information DB 14 with respect to the access request associated with the allowed basic permission attribute and determines whether the access request should be allowed. Specifically, in the example described above, it is notified from the VFS 13 that the basic permission attribute “Write” corresponding to “FILE_WRITE_DATA” is allowed. The second access control unit 16 refers to the access control information stored in the access control information DB 14 with respect to the permission “FILE_WRITE_DATA” of the access request associated with the allowed basic permission attribute “Write” and determines whether the access request should be allowed. Because the ACE “DENY FILE_WRITE_DATA 3394” is stored in the access control information DB 14, the second access control unit 16 denies the access request and outputs an indication that the access request is denied to the VFS 13. On the other hand, when the access request is allowed, the second access control unit 16 instructs the file system 17 to execute creation of a directory via the VFS 13.

The file system 17 includes data, devices, processes, and kernels for operating computer resources of the operating system (OS) and carries out data operation (access, retrieval, etc.). For example, the file system 17 is a second extended file system (ext2) or a third extended file system (ext3).

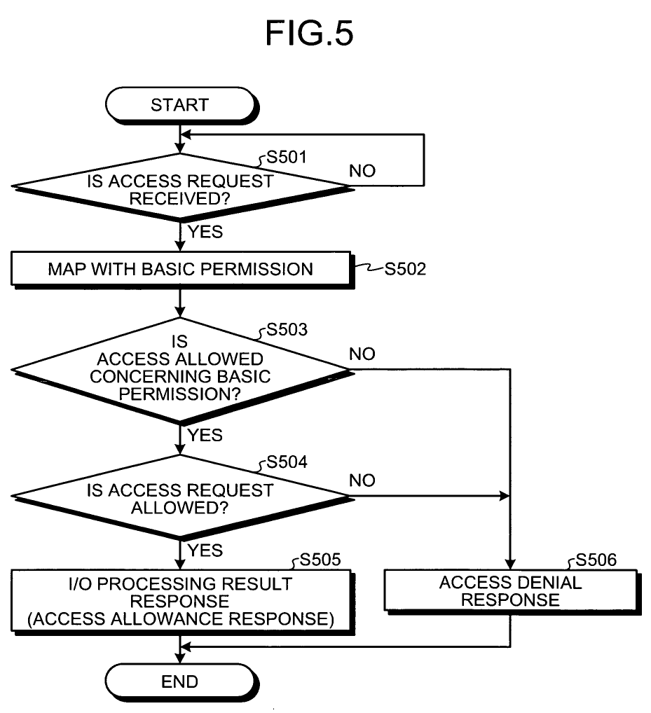

Processing of the file server will be described below with reference to FIGS. 5 to 7.

As shown in FIG. 5, the smbd 11 of the file server receives an access request from a user terminal connected by the CIFS (“YES” at step S501). In response, the smbd 11 issues an I/O request according to the access request to the VFS 13. The VFS 13 associates the I/O request with any one of the read, write, and execute permissions that are the basic permission attributes of the access request used in the NFS and outputs a result of the association to the VFS 13 (step S502).

The VFS 13 instructs the first access control unit 15 to determine access permission based on the associated basic permission attribute is allowed. The first access control unit 15 associates the basic permission attributes with each of the items stored in the access control information DB 14. When the associated basic permission attribute is allowed concerning at least one of the items of access control information associated with the basic permission attribute, the first access control unit 15 determines to allow the basic permission attribute. When the associated basic permission attribute is denied concerning all the items of access control information, the first access control unit 15 determines to deny the basic permission attribute. In this way, the first access control unit 15 transmits the result of determination to the VFS 13 (step S503).

When the response transmitted from the first access control unit 15 indicates access allowance (“YES” at step S503), the VFS 13 instructs the second access control unit to determine detailed access permission of the access request is allowed. In response, the second access control unit 16 refers to the access control information stored in the access control information DB 14 with respect to the access request associated with the allowed basic permission attribute and determines whether the access request should be allowed (step S504).

When it is determined to allow the access request (“YES” at step S504), the second access control unit 16 notifies the smbd 11 via the VFS 13 of the result of the directory creation processing, which is the instruction to the file system 17 via the VFS 13 (step S505). On the other hand, when it is determined to deny the access request (“NO” at step S504), the second access control unit 16 notifies the smbd 11 of denial of the access request as an access denial response via the VFS 13 (step S506).

Referring back to step S503, when it is determined to deny the basic permission attribute (“NO” at step S503), the VFS 13 issues access denial response (step S506).

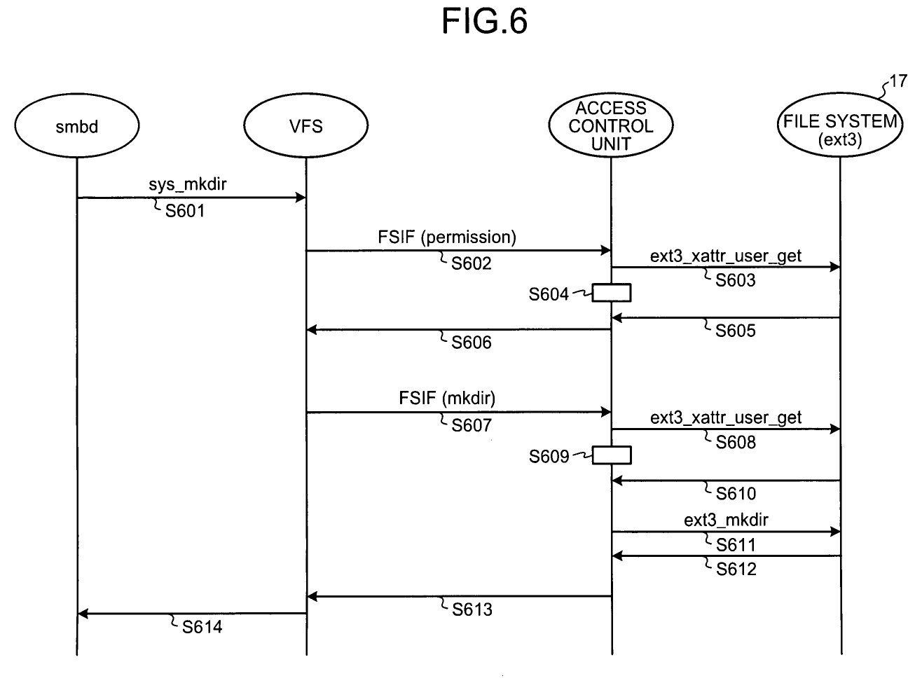

A processing sequence in the file server when to the access request is received in CIFS will be described below with reference to FIG. 6. In the following explanation, the file server receives an access request for “directory creation” from a user terminal.

As shown in FIG. 6, the smbd 11 that is a program of Samba receives an access request with the CIFS. The smbd 11 executes a system call “sys_mkdir” on the VFS 13 (step S601). Then, the VFS 13 executes a file system interface (FSIF) on an access control unit (hook driver) (S602). The access control unit includes the access control information DB 14, the first access control unit 15, and the second access control unit 16.

The access control unit executes an FSIF “ext3_xattr_user_get” on the file system 17 and acquires an extended attribute area (a user section). Further, the access control unit determines, using the smbd 11, whether any one of the basic permission attributes “Read”, “Write”, and “Exec” associated with a system call by the VFS 13 should be allowed and notifies the VFS 13 of a result of the determination (steps S603 to S606). It is assumed that the basic permission attribute is allowed by the access control unit.

The VFS 13 notified that the basic permission attribute is allowed executes an FSIF (mkdir) on the access control unit (step S607). The access control unit executes an FSIF “ext3_xattr_user_get” on the file system, acquires an extended attribute area (a user section), and determines whether the access request associated with the basic permission attribute is allowed (steps S608 to S610).

When it is determined that the FSIF (mkdir) is allowed, the access control unit executes a “directory creation” FSIF “ext3_mkdir” on the file system and outputs a result of the execution of “ext3_mkdir” to the VFS 13. The VFS 13 receives the result and transmits the result to the user terminal via the smbd 11 (steps S611 to S614).

Processing for determining whether a received access request should be allowed or denied is basically carried out according a general access list evaluation rule.

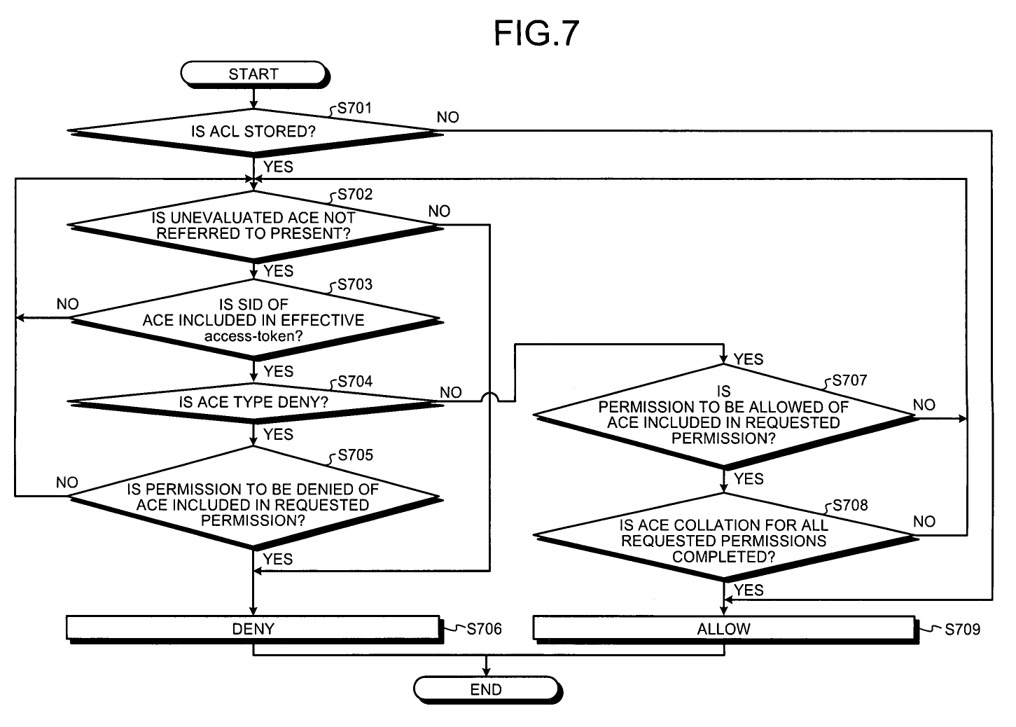

In the access evaluation rule shown in FIG. 7, an ACE array stored in the access control information DB 14 is scanned in order from the top until ACEs allowing all requested permissions are detected or until an ACE denying at least one of the requested permissions is detected. For example, in the access evaluation rule, the ACE array stored in the access control information DB 14 is scanned in order from the top until an ACE “ALLOW FILE_ADD_SUBDIRECTORY” allowing only one permission “FILE_ADD_SUBDIRECTORY” requested by the FSIF (mkdir) is detected or an ACE “DENY FILE_ADD_SUBDIRECTORY” denying the same permission is detected.

As shown in FIG. 7, the file server receives an access request and determines whether information (ACL) corresponding to the access request is stored in the access control information DB 14 (step S701).

When it is determined that the information is stored in the access control information DB 14 (“YES” at step S701), the file server determines whether an unevaluated ACE not referred to is present in ACLs stored in the access control information DB 14 (step S702).

When an unevaluated ACE is present (“YES” at step S702), the file server determines whether an SID of the ACE is included in an effective access-token (a set of identifiers SID of the access requester) (step S703).

When the SID of the ACE is included in the effective access-token (“YES” at step S703), the file server determines whether a type of the ACE is “DENY” (step S704).

Thereafter, when the ACE type is “DENY” (“YES” at step S704) and a permission to be denied of the ACE is included in a requested permission (“YES” at step S705), the file server determines to deny the access request (step S706).

When the ACE type is not “DENY” (“NO” at step S704), a permission to be allowed of the ACE is included in the requested permission (“YES” at step S707), and collation of ACEs of all requested permissions is completed (“YES” at step S708), the file server determines to allow the access request (step S709).

When the SID of the ACE is not included in the effective access-token (“NO” at step S703), when a permission to be denied of the ACE is not included in the requested permission (“NO” at step S705), when a permission to be allowed of the ACE is not included in the requested permission (“NO” at step S707), or when collation of the ACEs of all the requested permissions is not completed (“NO” at step S708), the file server returns to step S702 and executes the processing at step S702 and the subsequent steps.

When the file server receives an access request and information concerning a file of the target of access request (ACL) is not stored in the access control information DB 14 (“NO” at step S701), the file server determines to allow the access request (step S709). When an unevaluated ACE not referred to among ACLs of stored access control information remains (“NO” at step S702), the file server determines to deny the access request (step S706).

As described above, according to the first embodiment, the access control information indicating whether access request is allowed or denied for each of objects of the file system is stored. It is determined whether the basic permission attributes, which is associated with the access request received from the user terminal connected by the CIFS, of the access request used in NFS is allowed with reference to items of the access information each stored and each associated with any one of basic permission attributes. The access control information stored in the access control information DB 14 is referred to with respect to the access request associated with the allowed basic permission attribute and it is determined whether the access request is allowed. Therefore, it is possible to establish, with manhours fewer than those in the technology in the past, a file server that can perform accurate access control.

For example, because of an internal interface specification in the past of the UNIX (registered trademark) system, an access request can be checked on only the three kinds of permissions “the read, write, and execute permissions”. However, even if an access request classified more in detail than a UNIX (registered trademark) access request is received from a user terminal connected by a WINDOWS (registered trademark) CIFS, the detailed access request can be determined after being converted in to a UNIX (registered trademark) access request once. As a result, it is unnecessary to process the detailed access request while forcibly associating the detailed access request with the UNIX (registered trademark) access request. The detailed access request can be processed as it is. Therefore, it is possible to realize accurate access control.

It is unnecessary to establish an independent file server that does not depend on Windows (registered trademark) and UNIX (registered trademark). It is possible to establish a file server using a UNIX (registered trademark) OS and controls accesses from both Windows (registered trademark) and UNIX (registered trademark) user terminals. As a result, it is possible to reduce manhours required until the file server is established.

According to the first embodiment, when the basic permission attribute associated in response to the access request received from the user terminal connected by the CIFS is allowed concerning at least one of the items of access control information associated with the basic permission attribute, the file server determines to allow the basic permission attribute. When the associated basic permission attribute is denied concerning all the items of access control information, the file server determines to deny the basic permission attribute. Therefore, an access request can be controlled not strictly first and, then, controlled in detail. As a result, it is possible to realize more accurate access control.

For example, when “FILE_WRITE_EA” that is a Windows (registered trademark) access request is received, this access request is converted as “Write” in UNIX (registered trademark). If at least one permission concerning “Write” is allowed in access control information, i.e., if “FILE_WRITE_ATTRIBUTES” is denied regardless of “FILE_WRITE EA” but “FILE_WRITE_DATA” is allowed, the received access request is regarded as allowed. Then, it is determined whether actual “FILE_WRITE_EA” is allowed.

On the other hand, when all permissions concerning “Write” are denied in the access control information, i.e., if “FILE_WRITE_ATTRIBUTES” is denied and “FILE_WRITE DATA” is also denied regardless of “FILE_WRITE_EA”, the received access request is denied and “FILE_WRITE_EA” is denied.

In this way, because of an internal interface specification in the past of the UNIX (registered trademark) system, an access request can be checked on only the three types of permission attributes, the read, write, and execute permissions. Therefore, when an access request classified in detail is received from a user terminal connected by the Windows (registered trademark) CIFS, replaced with an access request in UNIX (registered trademark), and determined strictly and forcibly by a first access control unit, it is likely that the detailed access request, which should originally be allowed, is denied. Such failure of determination can be prevented by controlling the access request not strictly first and, then, controlling the access request in detail. As a result, it is possible to realize more accurate access control.

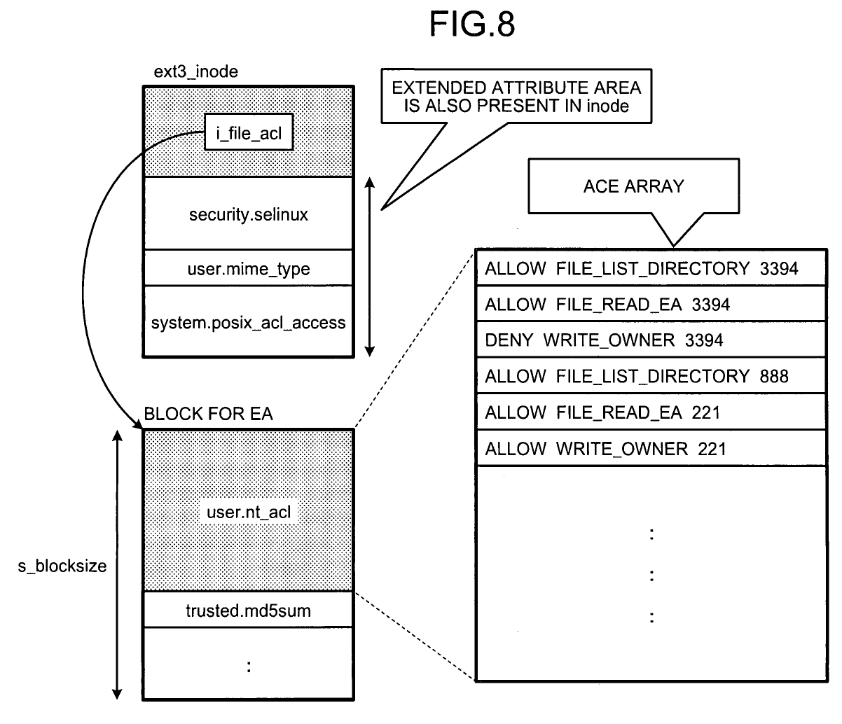

The association of the items of the access control information with the basic permission attributes in the first embodiment may be provided in a variety of forms. For example, the file server according to the present invention the access control information to be stored in the access control information DB in the first embodiment may be stored in an extended attribute area of an inode in which information concerning each object on the file system is stored. For example, as shown in FIG. 8, “user.nt_at1” is created in an extended attribute area (EA) of an inode of the file system (ext3) so that the access control information is stored in the EA.

Consequently, it is possible to generate access control information and extended metadata in an arbitrary format. As a result, it is possible to minimize correction of the file system and the VFS. For example, it is possible to use an arbitrary data format by using a USER area as the extended area without using POSIX-ACL/LIDS•SELINUX and the like, data formats of which are decided in advance. Therefore, it is possible to minimize correction of the file system and the VFS.

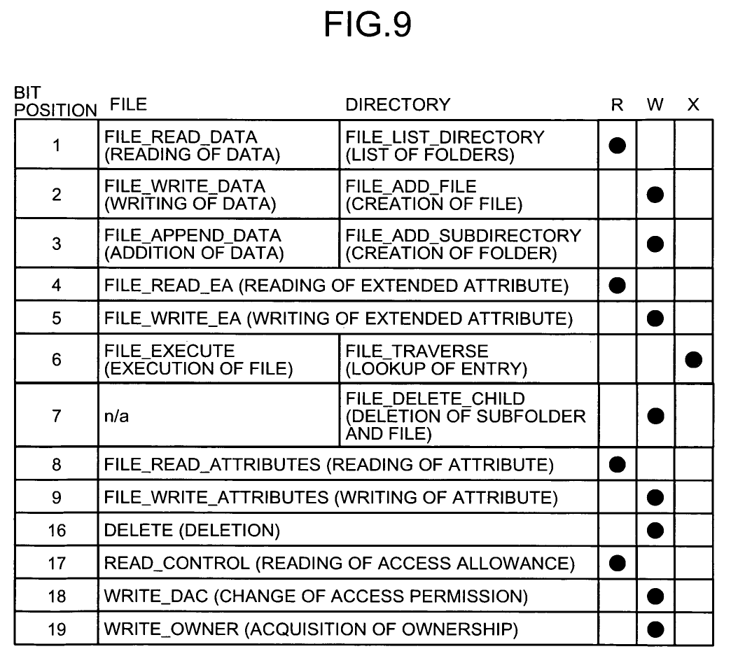

The association of access request and basic permission attributes explained in the first embodiment can be stored in advance. For example, it is also possible that, as shown in FIG. 9, a table in which “FILE_READ_DATA (reading of data)” is associated with “R (Read)”, “WRITE_DAC (change of access allowance) is associated with “Write”, and “FILE_TRAVERSE (LOOKUP of entry)” is associated with “X (execution)” and the like is stored and a received access request is converted into a basic permission attribute referring to this table.

In the embodiment, when access control information is stored in the file system, it is also possible to guarantee atomicity of the access control information. Moreover, unlike the first embodiment, it is also possible to skip processing at a first stage of access control at a second stage only for a request received from a user terminal connected by the CIFS.

Therefore, in a second embodiment of the present invention, the access control information, atomicity of which is guaranteed, is stored and accurate access control is carried out in the access control at a first stage. Various functions explained in the second embodiment are only illustration for explanation. Functions are not limited to these functions.

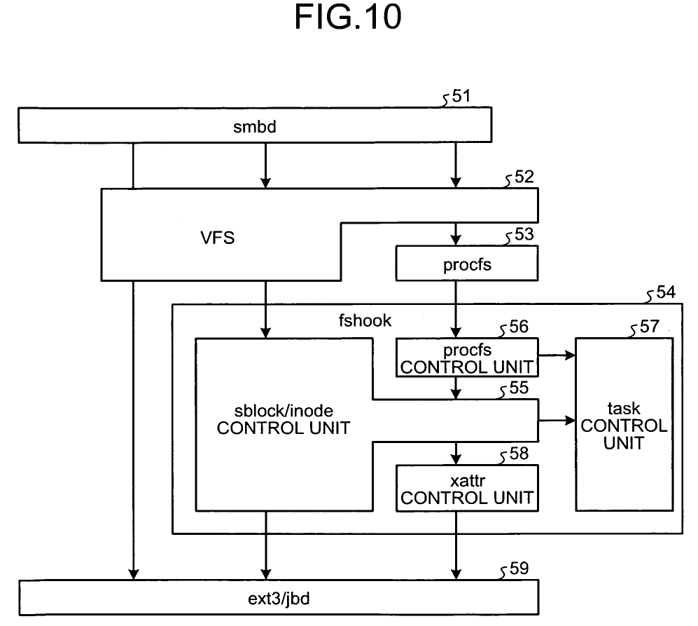

The structure of a file server according to the second embodiment will be described below with reference to FIG. 10. As shown in FIG. 10, the file server includes an smbd 51, a VFS 52, a procfs 53, an fshook 54, and an ext3/jbd 59. The smbd 51, the VFS 52, and the ext3/jbd 59 have the same functions as those of the smbd 11, the VFS 13, and the file system 17 explained in the first embodiment. Therefore, detailed explanation of the devices is omitted. The procfs 53 and the fshook 54 having functions different from those in the first embodiment are explained.

The procfs 53 is an interface that is located between the VFS 52 and the fshook 54 and controls any types of communication, except system calls, between the VFS 52 and the fshook 54. Specifically, for example, the procfs 53 receives an access request, an access control information storage request, and the like from the smbd 51 via the VFS 52. The procfs 53 notifies a procfs control unit 56 of the fshook 54 described later of the received various kinds of information.

The fshook 54 controls various kinds of processing applied to the ext3/jbd 59 that is a file system including a general-purpose journal device mechanism (jbd). The fshook 54 includes, in particular, as units closely related to the present invention, a sblock/inode control unit 55, the procfs control unit 56, a task control unit 57, and a xattr control unit 58.

The sblock/inode control unit 55 hooks various kinds of control of the ext3/jbd 59 as a file system and adds a function of NT-ACL control (access control). Specifically, for example, the sblock/inode control unit 55 has functions for adding an NT-ACL control (access control) function such as a function for initializing and finishing an fshook module, a function for performing hook setting of an FSIF, and a hook function of the FSIF for applying various kinds of processing (e.g., for mount/unmount processing, extended attribute setting processing, attribute/size setting, etc.) to the ext3. With these functions, the sblock/inode control unit 55 sufficiently hooks the various kinds of control of the ext3/jbd 59 to add a function for access control.

Hook methods (methods of setting hook functions) for three function tables “file_system_type”, “super_operations”, and “inode_operations” including an FSIF particularly related to the embodiment are explained. The function table “file_system_type” includes an FSIF(get_sb) that performs mount of an FS volume and an FSIF(kill_sb) that performs unmount of the FS volume. The FSIF(get_sb) performs processing for setting the function table “super_operations”. If the FSIF(get_sb) is hooked, it is possible to hook the function table “super_operations”. Therefore, the function table “file_system_type” is hooked. For example, the fsfook 54 is mounted as a loadable kernel module (LKM) and forcibly loaded before mount of a hook object FS volume (e.g., loaded in modprobe after mounting a root partition in rc.sysinit). The FSIF(get_sb) and the FSIF(kill_sb) in the function table “file_system_type” of the ext3/jbd 59 are replaced with a hook function (fshook_get_sb) and a hook function (fshook_kill_sb) for mediating the fsfook 54 by a module_init function invoked at the time of the load.

The function table “super_operations” includes an FSIF(alloc_inode) and an FSIF(read_inode) that perform operation of superblock (FS volume). The FSIF (read_inode) performs processing for setting a function table “inode_operations”. If the FSIF(read_inode) is hooked, it is possible to hook the function table “inode_operations”. Therefore, the function table “super_operations” is hooked. For example, in the hook function (fshook_get_sb) of the FSIF(get_sb) of file_system_type described above, after the end of get_sub processing of the ext3/jbd 59, suer_operations for the ext3/jbd 59 set in super_block is replaced with a copy tampered to include a hook function for mediating the fshook 54.

The function table “inode_operations” includes an FSIF(create), an FSIF(lookup), and an FSIF(getattr) that operate the inode (FS object). The function table “inode_operations” is hooked because it is necessary to apply function extension of the NT-ACL control (access control) to these FSIFs. For example, concerning the function table “inode_operations” of a root directory, an inode of the root directory set in super_block is acquired at timing same as that of setting of a hook function of the function table “super_operations”. The function table “inode_operations” for the ext3/jbd 59 set in the inode is replaced with a copy tampered to including the hook function for mediating the fshook 54. For example, concerning the function table “inode_operations” of an existing file other than the root directory, in the hook function (fshook_read_inode) of the FSIF (read_inode) that loads a disk_inode image at the time of initialization of an in-core inode of the function table, the function table “inode_operations” for ext3/jbd 59 set in the inode is replaced with a copy tampered to include the hook function for mediating the fshook 54 after the end of the processing in the ext3/jbd 59. Moreover, for example, concerning the function table “inode_operations” of a newly created file, in FSIF (create)/FSIF (mkdir)/FSIF (symlink) of the function table “inode_operations” of a parent directory at the time of the new creation, the function table “inode_operations” for the ext3/jbd 59 set in an inode of the newly created file is replaced with a copy tampered to include the hook function for mediating the fshook 54 after the end of the processing in the ext3/jbd 59.

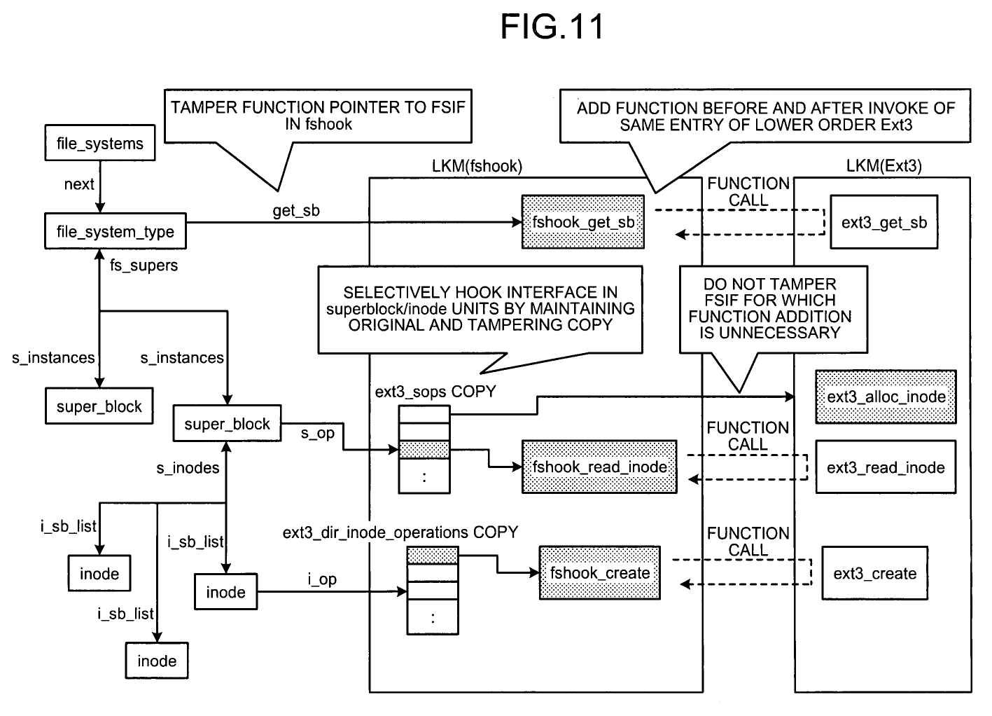

According to the method of setting a hook function described above, as shown in FIG. 11, it is possible to selectively hook a standardized and stable interface between VFS and FS (FSIF) for the purpose of coping with various FSs and apply function extension for performing access control based on an NT-ACL as required while using processing of the FS (ext3). It is also possible to selectively hook an FSIF in superblock/inode units by maintaining an original of the FS volume of the file system and tampering a copy. For example, an FSIF for which addition of functions is unnecessary such as “ext3_alloc_inode” is not hooked and processing for the FSIF is executed by the ext3. FSIFs for which addition of functions is necessary such as “fshook_read_inode”, “fshoo_create”, and “fshoo_get_sb” are hooked by the fshook 54.

It is also possible to newly add an option for instructing hook of an I/O of a volume of the file system to a mount request for the volume and hook the function table “super_operations” of the volume only when the option is detected by the hook function fshook_get_sb of the FSIF(get_sb). In other words, it is possible to perform selective hook for each volume using the option.

The file server can also count the number of volumes hooked by the function in the hook driver and perform control to prohibit unload of the driver while the count remains. Consequently, it is possible to prevent halfway release of the hook (panic stop due to disappearance of a redirect destination of the FS interface).

The procfs control unit 56 controls data exchange with the smbd 51 performed by using the procfs 53. Specifically, for example, the procfs control unit 56 has a function for performing initial registration/end processing for a procfs entry of the fshook 54, a function for responding to a module release instruction (fulfillment of unload conditions) of the fshook 54, a function for updating the number of communication sessions with the smbd 51, a function for responding to setting and reference instructions for security descriptor (sd) information, a function for capturing various data on a user memory space or a kernel memory space, and the like. The procfs control unit 56 controls data exchange with the smbd 51 using these functions.

The task control unit 57 performs birth-and-death check for an fshook associated smbd process and exchange control for syscall extension data in task units. Specifically, for example, the task control unit 57 has a function for newly creating or discarding an fshook_task structure that manages session with the smbd 51, a function for setting sd information and a DOS attribute used in creating a file or a directory in the fshook_task structure corresponding to the session, a function for calculating or clearing addresses of the sd information and DOS attribute information set in the fshook_task structure corresponding to each communication session with the smbd 51, and the like. The task control unit 57 performs birth-and-death check for the fshook associated smbd process and exchange control for syscall extended data in task units using these functions.

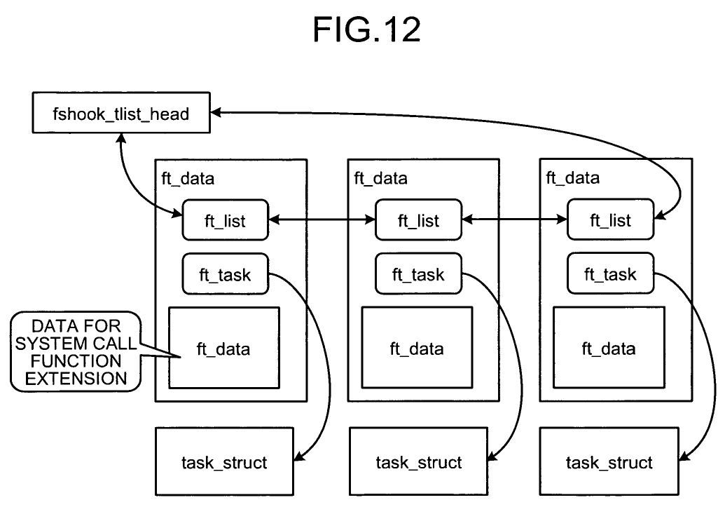

The task control unit 57 performs state control for communication from the samba for each kernel task structure (task_struct) and manages an fshook_task structure (see FIG. 12) that manages saving of data for system call extension provided from the samba. The fshook_task structure shown in FIG. 12 includes request data (IOC_SD_PARAM), which is passed in ioctl to a com file of procfs, in a member ft_data in a passed state and prepares for reference from the FSIF(create), the FSIF(mkdir), and the like. Because all tables of this control are in-core, the tables are subjected to exclusive processing by spin lock (fshook_tlist_lock).

The xattr control unit 58 performs control of metadata applicable to NT-ALC (see FIG. 8) of the extended attribute area of the file system (ext3/jbd 59). Specifically, for example, the xattr control unit 58 has various functions concerning access control such as a function for performing processing permission check based on the NT-ACL, a function for referring to data or the size of the NT-ACL, a function for setting, updating, and deleting the NT-ACL, a function for setting/updating a DOS attribute and referring to data or a size of the DOS attribute, a function for listing allowed NT-ACL permissions among designated NT-ACL permissions, and a function for creating dacl or sacl taking into account sd information set by prepare and permission verification from the parent directory. The xattr control unit 58 performs control of metadata applicable to NT-ALC in the extended attribute area of the file system using these functions.

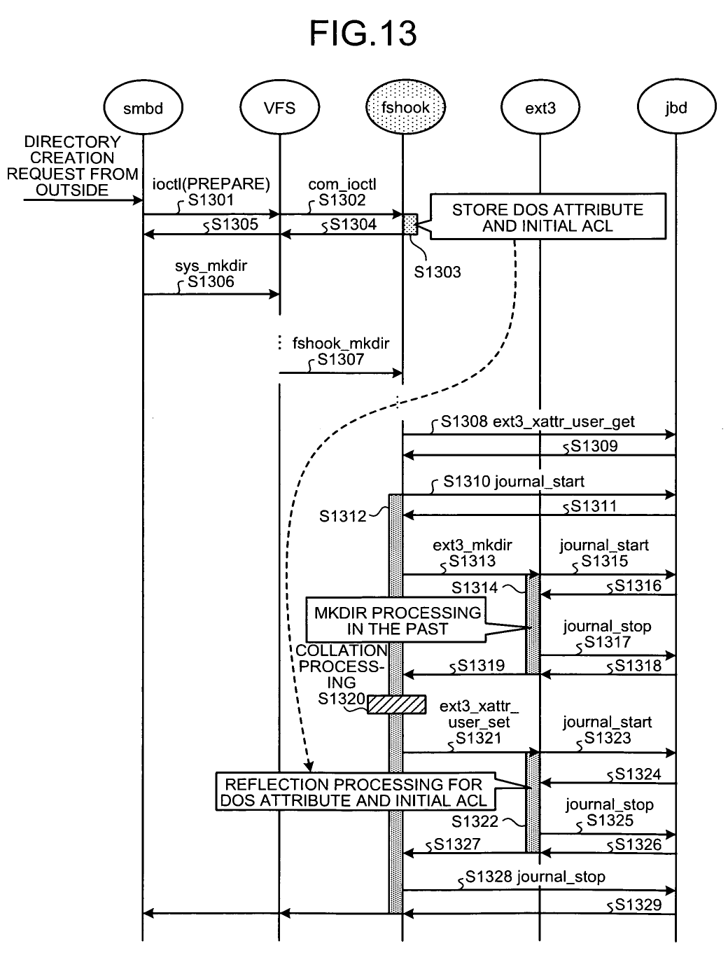

A flow of processing of the file server according to the second embodiment will be described below with reference to FIG. 13.

In the file server according to the second embodiment, in creation of a file or a directory according to a CIFS protocol, it is possible to instruct setting of additional meta information such as a DOS attribute and an NT-ACL for a new file or a new directory. In Linux system call in the past, because these kinds of additional meta information cannot be transmitted, additional information is provided in another IOCTL before a system call is issued.

As shown in FIG. 13, after receiving a directory creation request by the CIFS protocol from a user terminal and before issuing a system call “sys_mkdir” for performing directory creation to the VFS 52, the smbd 51 adds access control information for a directory to be created to IO control (ioctl(PREPARE)) different from the system call and transmits the IO control added with the access control information to the VFS 52 (step S1301). The VFS 52 outputs the IO control added with the access control information to the fshook 54 as “com_ioctl” (step S1302).

The fshook 54 stores “an ODS attribute and an initial ACL”, which are the access control information received from the VFS 52, and a context in a predetermined storage area (e.g., a temporary area) (step S1303). The fshook 54 notifies the smbd 51 of a response to the access control information via the VFS 52 (steps S1304 and S1305).

Thereafter, the VFS 52 receives “sys_mkdir” from the smbd 51 and notifies the fshook 54 of this call through a hook function fshook_mkdir set in advance (steps S1306 and S1307).

The fshook 54 executes an FSIF “ext3_xattr_user_get” on the file system (jbd) and acquires an extended attribute area (a user section) (steps S1308 and S1309).

The fshook 54 acquires the extended attribute area (the user section) and issues an FSIF “journal_start” for starting a journal for storing the access control information to the file system (jbd) (steps S1310 and S1311). Concerning processing after this, the fshook 54 executes storing processing in each of sessions of journals identical with respective journals for respective kinds of metadata update processing carried out in the file system to thereby guarantee atomicity of update of all metadata as the system call “sys_mkdir” (step S1312).

The fshook 54 executes “ext3_mkdir” of an FSIF “directory creation” on the file system (ext3) and executes “directory creation=MKDIR” (steps S1313 and S1314). The fshook 54 issues an FSIF “journal_start” for starting a journal of “directory creation” to the file system (jbd) (steps S1315 and S1316).

The system file (ext3) finishes “directory creation” and issues an FSIF “journal_stop” for finishing the journal of “directory creation” to the file system (jbd) (step S1317).

Thereafter, the fshook 54 is informed via the file system (jbd) and the file system (ext3) that the journal of “directory creation” is finished. The fshook 54 performs collation of the context stored in the predetermined storage area and determines whether the access control information to be stored coincides with the access control information stored at step S1303 (steps S1318 to S1320).

When the context stored in the predetermined storage area coincides a context of the stored access control information and thus it is determined that the access control information is the access control information stored at step S1303, the fshook 54 issues an FSIF “ext3_xattr_user_set” to the file system (ext3) (step S1321).

The file system (ext3) issues an FSIF “journal_start” for starting a journal of “access control information storage” to the file system (jbd) (steps S1323 and S1324). Then, the file system (ext3) executes “access information storage (processing for reflecting the DOS attribute and the initial ACL)” for acquiring the access control information stored in the predetermined storage area and storing the access control information in the extended area (inode) (step S1322).

When “access control information” is finished, the file system (ext3) issues an FSIF “journal_stop” for finishing the journal of “access control information storage” to the file system (jbd) (step S1325).

Thereafter, the fshook 54 is informed via the file system (jbd) and the file system (ext3) that the journal of “access control information storage” is finished (steps S1326 and S1327). The fshook 54 issues an FSIF “journal_stop” for finishing the journal for storing the access control information to the file system (jbd), i.e., finishes execution of the storing processing in the sessions of journals identical with the respective journals for the respective kinds of metadata update processing carried out in the file system (step S1328). The fshook 54 receives a result of the processing from the file system (jbd) and notifies the user terminal of the result via the smbd 51 (step S1329).

In the directory new creation processing explained referring to FIG. 13, the ACL initial setting is explicitly indicated. However, when the ACL initial setting is not explicitly indicated, an ACL of the parent directory is inherited instead of the ACL initial setting. According to a regular rule, only when an inheritance destination file does not prohibit inheritance, the AC-L of the parent directory is scanned and an ACE is selectively inherited.

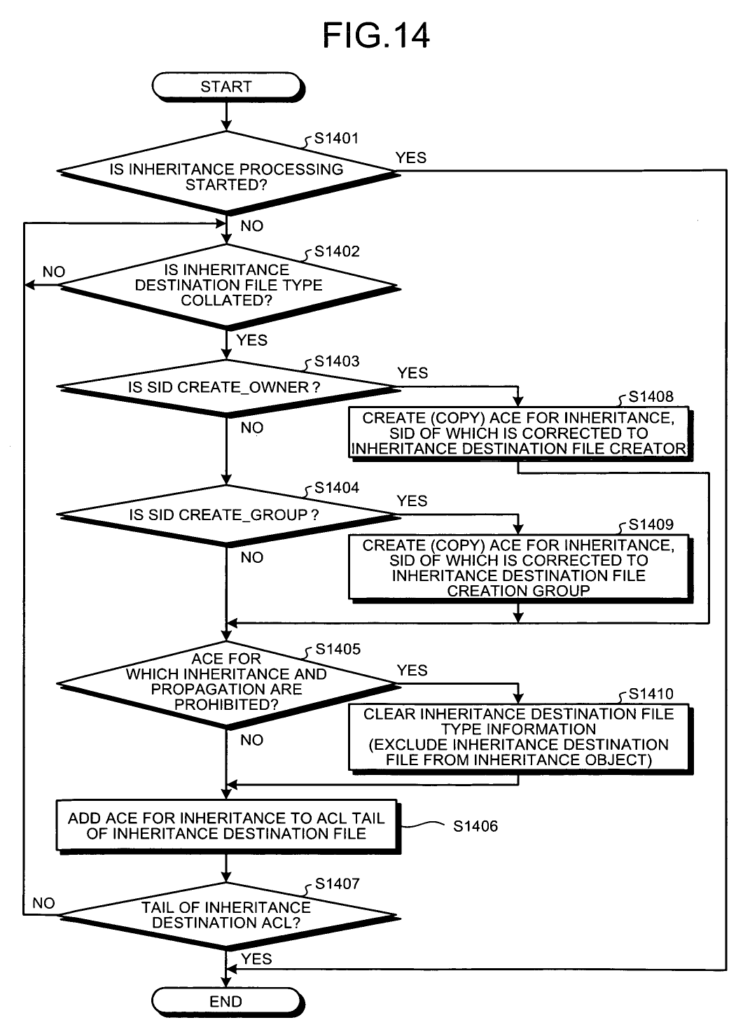

A flow of ACL inheritance processing according to the second embodiment will be described below with reference to FIG. 14.

As shown in FIG. 14, when the inheritance destination file does not deny inheritance and an inheritance processing is started (“NO” at step S1401), the file server performs collation of whether file-type attribute data of the ACE, which is being checked, of the ACL of the inheritance source file currently referred to matches the type of the inheritance destination file (S1402). When the file-type attribute data of the ACE matches the type of the inheritance destination file (“YES” at step S1402), the file server determines whether an SID of the ACE is CREATE_OWNER (step S1403).

When the SID of the inheritance destination file is not CREATE_OWNER (“NO” at step S1403), the file server determines whether the SID of the ACE is CREATE_GROUP (step S1404).

Thereafter, when the SID of the ACE is not CREATE_GROUP (“NO” at step S1404), the file server determines whether the ACE is an ACE for which inheritance and propagation are prohibited (step S1405).

When the ACE is not an ACE for which inheritance and propagation are prohibited (“NO” at step S1405), the file server adds an ACE for inheritance to an ACL tail of the inheritance destination file (step S1406) and determines whether the ACE is a tail of an inheritance source ACL (step S1407).

When the ACE is the tail of the inheritance destination ACL (“YES” at step S1407), the file server finishes the processing. When the ACE is not the tail of the ACL (“NO” at step S1407), the file server repeats the processing at step S1402 and the subsequent steps.

Referring back to step S1403, when the SID of the ACE is CREATE_OWNER (“YES” at step S1403), the file server creates (copies) the ACE for inheritance, the SID of which is corrected to an inheritance destination file creator (step S1408) and executes the processing at step S1405 and the subsequent steps.

When the SID of the ACE is CREATE_GROUP (“YES” at step S1404), the file sever creates (copies) the ACE for inheritance, the SID of which is corrected to an inheritance destination file creation group, (step S1409) and executes the processing at step S1405 and the subsequent steps.

When the ACE is an ACE for which inheritance and propagation are prohibited (“YES” at step S1405), the file server clears inheritance destination file type information (excludes the inheritance destination file from an inheritance object) (step S1410) and executes the processing at step S1406 and the subsequent steps.

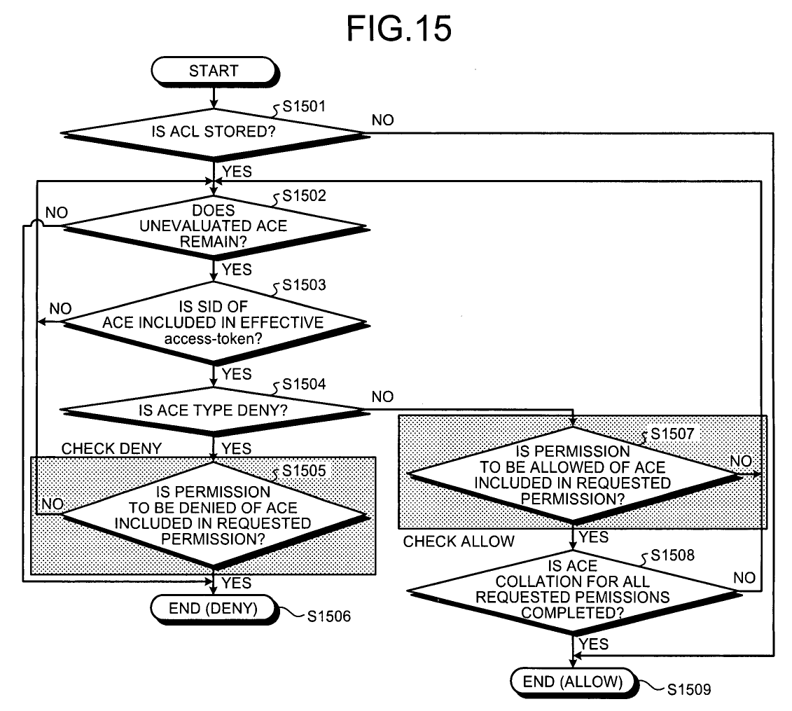

A flow of access control (NT-ACL evaluation processing) performed by using the access control information stored by the processing sequences shown in FIGS. 13 and 14 will be described below with reference to FIG. 15.

As shown in FIG. 15, when an access request is received and an ACL corresponding to the access request is stored in the inode (“YES” at step S1501), the file server determines whether an unevaluated ACE not referred to remains among ACLs of stored access control information (step S1502).

When an unevaluated ACE is present (“YES” at step S1502), the file server determines whether an SID of the ACE is included in an effective access-token (step S1503).

When the SID of the ACE is included in the effective access-token (“YES” at step S1503), the file server determines whether the type of the ACE is “DENY” (step S1504).

Thereafter, when the ACE type is “DENY” (“YES” at step S1504) and a permission to be denied of the ACE is included in a requested permission (“YES” at step S1505), the file server determines to deny the access request (step S1506).

When the ACE type is not “DENY” (“NO” at step S1504), a permission to be allowed of the ACE is included in the requested permission (“YES” at step S1507), and ACE collation for all requested permissions is completed (“YES” at step S1508), the file server determines to allow the access request (step S1509).

When the SID of the ACE is not included in the effective access-token (“NO” at step S1503), when the permission to be denied of the ACE is not included in the requested permission (“NO” at step S1505), when the permission to be allowed of the ACE is not included in the requested permission (“NO” at step S1507), or when the ACE collation for all the requested permissions is not completed (“NO” at step S1508), the file server returns to step S1502 and executes the processing at step S1502 and the subsequent steps.

When the file server receives an access request and an NT-ACL information is not stored in the inode of the file corresponding to the access request (“NO” at step S1501), the file server determines to allow the access request (step S1509). When an unevaluated ACE not referred to does not remain among ACLs of stored access control information (“NO” at step S1502), the file server determines to deny the access request (step S1506).

As described above, according to the second embodiment, when a directory creation request is received from a user terminal connected by the CIFS, before a system call for performing directory creation is issued in response to the directory creation request, access control information for the directory indicating whether an access request is allowed concerning respective objects of the file system is added to an I/O control different from the system call and issued. Storage processing for storing access control information issued via the I/O control in an extended attribute area of the inode on the file system is executed in each of sessions of journals identical with respective journals for respective kinds of metadata update processing carried out in the file system. When an access request is received from a user terminal connected by the CIFS, it is determined based on the access control information stored in the file system whether the access request is allowed. Therefore, it is possible to carry out access control using access control information, atomicity of which is guaranteed. As a result, it is unnecessary to process a detailed access request while forcibly associating the detailed access request with a UNIX (registered trademark) access request. The detailed access request can be processed as it is. Therefore, it is possible to realize more accurate access control.

According to the second embodiment, concerning a volume of the file system accessed from the user terminal connected by the CIFS, an interface concerning a root directory and metadata of the file system is hooked and, when an interface concerning a directory of a mount destination is hooked, an interface concerning a file right below the directory is hooked, whereby a file system interface concerning the mounted volume is sufficiently hooked. Therefore, rather than tampering an interface function vector, it is possible to direct a pointer of a pointer source (a super block or an inode) thereof to a tampered interface function vector. As a result, it is possible to realize volume-limited hook setting and make it unnecessary to perform exclusive control concerning hook setting processing with a volume not to be hooked.

According to the second embodiment, concerning a volume of the file system accessed from the user terminal connected by the CIFS, only when an identifier indicating that the volume is a hook object is added to a mount option included in a mount request for mounting the volume, it is determined that the volume is the hook object. Therefore, it is possible to prevent setting of hook concerning an unrelated volume.

According to the second embodiment, the number of hooked volumes is counted in a hook driver and unload of the driver is prohibited while the count remains. Therefore, it is possible to prevent halfway release of the hook (panic stop due to disappearance of a redirect destination of the FS interface).

According to the second embodiment, when access control information is stored in the extended attribute area of the inode on the file system, in the I/O control, a context is temporarily stored in the hook driver in the kernel together with the access control information. In the system call, it is determined whether the context coincides with that of received correct access control information. On condition that the access control information is the received correct access control information, the access control information is stored in the extended attribute area. Therefore, it is possible to appropriately determine a relation between the IO control and the system call.

The embodiments of the present invention have been explained. However, the present invention can be carried out in various different forms other than the embodiments described above. Different embodiments concerning CIFS connection by Samba, a system configuration, and a program are explained below.

In the first embodiment, the program (smbd daemon) of Samba is executed to receive an access request from the user terminal connected by the CIFS. However, the present invention is not limited to this. For example, it is also possible to use original programs and publicly-known technologies and programs, and the like that makes it possible to perform CIFS connection.

The respective components of the respective devices shown in the figures are functionally conceptual and do not always have to be physically configured as shown in the figure. A specific form of distribution and integration of the devices is not limited to that shown in the figures. All or a part of the devices can be functionally or physically distributed or integrated (e.g., the access-request receiving unit and the access-request responding unit are integrated) in arbitrary units according to various loads, states of use, and the like. Moreover, all or an arbitrary part of the respective processing functions performed in the respective devices can be realized by a central processing unit (CPU) or a program analyzed and executed by the CPU or can be realized as hardware by a wired logic.

All or a part of the kinds of processing (e.g., the processing for determining whether a received access request is a CIFS or an NFS) explained as being automatically performed can be performed manually. Alternatively, all or a part of the kinds of processing (e.g., processing for creating access control information) explained as being performed manually can be automatically performed by a publicly-known method. Besides, the processing procedures, the control procedures, the specific names, and the information including various data and parameters described in this document and shown in the drawings (e.g., FIGS. 4, 8, and 9) can be arbitrarily changed unless specifically noted otherwise.

The various kinds of processing explained in the embodiment can be realized by executing programs prepared in advance in a computer system such as a personal computer or a workstation. A computer system that executes programs having functions same as those in the embodiment is explained below as another embodiment.

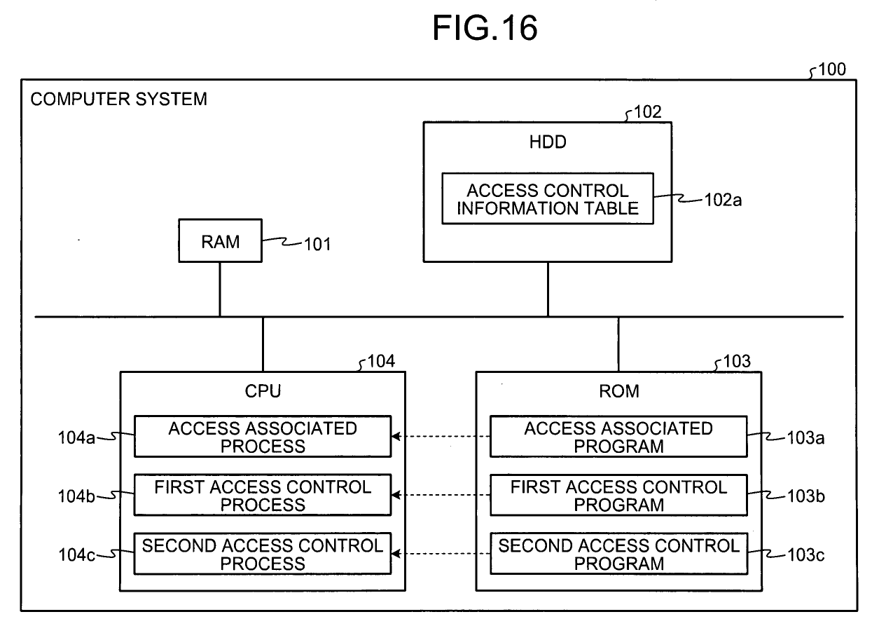

As shown in FIG. 16, the computer system 100 includes a read only memory (RAM) 101, a hard disk (HDD) 102, a read only memory (ROM) 103, and a central processing unit (CPU) 104. Programs that realize the same functions as those in the embodiment described above, i.e., an access associated program 103a, a first access control program 103b, and a second access control program 103c are stored in advance as shown in FIG. 16.

When the CPU 104 reads out and executes these programs 103a to 103c, these programs change to an access associated process 104a, a first access control process 104b, and a second access control process 104c as shown in FIG. 16. The access associated process 104a, the first access control process 104b, and the second access control process 104c correspond to the smbd 11, the first access control unit 15, and the second access control unit 16 shown in FIG. 3, respectively.

In the HDD 102, an access control information table 102a that stores access control information indicating whether access to the respective objects of the file system is allowed or denied is provided. The access control information table 102a corresponds to the access control information DB 14 shown in FIG. 3.

The programs 103a to 103c do not always have to be stored in the ROM 130. For example, the programs 103a to 103c can also be stored in stationary physical media such as a hard disk provided on the inside and the outside of the computer system 100 and other computer systems connected to the computer system 100 through a public line, the Internet, a local area network (LAN), a wide area network (WAN), and the like besides portable physical media such as a flexible disk (FD), a compact disk-read only memory (CD-ROM), a magneto-optical (MO) disk, a digital versatile (DVD) disk, a magneto-optical disk, and an IC card. The computer system 100 can read out the programs from these devices and execute the programs.

According to the embodiment, it is possible to establish, with manhours fewer than those in the technology in the past, a file server that can perform accurate access control.

For example, because of an internal interface specification in the past of the UNIX (registered trademark) system, an access request can be checked on only the three kinds of permissions, the read, write, and execute permissions. However, even if an access request classified more in detail than a UNIX (registered trademark) access request is received from a user terminal connected by a WINDOWS (registered trademark) CIFS, the detailed access request can be determined after being converted in to a UNIX (registered trademark) access request once. As a result, it is unnecessary to process the detailed access request while forcibly associating the detailed access request with the UNIX (registered trademark) access request. The detailed access request can be processed as it is. Therefore, it is possible to realize accurate access control.

It is unnecessary to establish an independent file server that does not depend on Windows (registered trademark) and UNIX (registered trademark). It is possible to establish a file server using a UNIX (registered trademark) OS and controls accesses from both Windows (registered trademark) and UNIX (registered trademark) user terminals. As a result, it is possible to reduce manhours required until the file server is established.

According to the embodiment, an access request can be controlled not strictly first and, then, controlled in detail. As a result, it is possible to realize more accurate access control.

For example, because of an internal interface specification in the past of the UNIX (registered trademark) system, an access request can be checked on only the three kinds of permissions “the read, write, and execute permissions”. Therefore, when an access request classified in detail is received from a user terminal connected by the Windows (registered trademark) CIFS, replaced with an access request in UNIX (registered trademark), and determined strictly and forcibly by a first access control unit, it is likely that the detailed access request, which should originally be allowed, is denied. Such failure of determination can be prevented by controlling the access request not strictly first and, then, controlling the access request in detail. As a result, it is possible to realize more accurate access control.

According to the embodiment, access control information is stored in an extended attribute area of an inode in which information concerning respective objects on a file system is stored. A USER area is used as the extended area rather than POSIX-ACL/LIDS•SELINUX, a data format of which is decided in advance. This makes it possible to use an arbitrary data format. Therefore, it is possible to minimize correction of a file system and a virtual file system (VFS).

According to the embodiment, it is possible to carry out access control using access control information, atomicity of which is guaranteed. As a result, it is unnecessary to process the detailed access request while forcibly associating the detailed access request with the UNIX (registered trademark) access request. The detailed access request can be processed as it is. Therefore, it is possible to realize more accurate access control.

According to the embodiment, rather than tampering an interface function vector, it is possible to redirect a pointer source (a super block or an inode) thereof to a tampered interface function vector. As a result, it is possible to realize volume-limited hook setting and make it unnecessary to perform exclusive control concerning hook setting processing with a volume not to be hooked.

According to the embodiment, it is possible to prevent setting of hook concerning an unrelated volume.

According to the embodiment, it is possible to prevent halfway release of hook (panic stop due to disappearance of a redirect destination of an FS interface).

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer program product having a computer readable medium including programmed instructions for receiving an access request to a file system from a user terminal through a common Internet file system (CIFS) or a network file system (NFS) and for determining whether the access request should be allowed, wherein the instructions, when executed by a computer, cause the computer to perform:
determining whether a basic permission attribute of an access request used in the NFS should be allowed with reference to access control information associated with basic permission attributes, the basic permission attribute being associated with an access request received from the user terminal through the CIFS, the access control information indicating whether an access request to respective objects of the file system should be allowed or denied, and the access control information being stored in an access-control-information storing unit; and
determining whether the access request associated with the allowed basic permission attribute should be allowed, in reference to the access control information stored in the access-control-information storing unit.

2. The computer program product according to claim 1, wherein the first determining includes determining, when the associated basic permission attribute is allowed concerning at least one of the items of access control information associated with the basic permission attribute, that the basic permission attribute is allowed and, when the basic permission attribute is denied concerning all the items of access control information, that the basic permission attribute is denied.

3. The computer program product according to claim 1, wherein the access-control-information storing unit stores the access control information in an extended attribute area of an inode in which information concerning the respective objects on the file system is stored.

4. An access control apparatus, connected to a user terminal by a common Internet file system (CIFS) or a network file system (NFS), for receiving a request for access to a file system from the user terminal, and for determining whether the access request should be allowed, the access control apparatus comprising:
an access-control-information storing unit that stores therein access control information indicating whether an access request to respective objects of the file system should be allowed or denied;
a first access control unit that determines whether a basic permission attribute of an access request used in the NFS should be allowed with reference to the access control information which is associated with basic permission attributes and is stored in the access-control-information storing unit, the basic permission attribute being associated with an access request received from the user terminal through the CIFS; and
a second access control unit that determines whether the access request associated with the allowed basic permission attribute should be allowed, in reference to the access control information stored in the access-control-information storing unit.

5. The access control apparatus according to claim 4, wherein the first access control unit determines, when the basic permission attribute associated by the access associating unit is allowed concerning at least one of items of the access control information associated with the basic permission attribute, that the basic permission attribute is allowed and determines, when the basic permission attribute is denied concerning all the items of the access control information, that the basic permission attribute is denied.

6. The access control apparatus according to claim 4, wherein the access-control-information storing unit stores the access control information in an extended attribute area of an inode in which information concerning the respective objects on the file system is stored.

7. An access control method for receiving an access request to a file system from a user terminal through a common Internet file system (CIFS) or a network file system (NFS) and for determining whether the access request should be allowed, the access control method comprising:
determining whether a basic permission attribute of an access request used in the NFS should be allowed with reference to access control information associated with basic permission attributes, the basic permission attribute being associated with an access request received from the user terminal through the CIFS, the access control information indicating whether an access request to respective objects of the file system should be allowed or denied, and the access control information being stored in an access-control-information storing unit; and
determining whether the access request associated with the allowed basic permission attribute should be allowed, in reference to the access control information stored in the access-control-information storing unit.

8. The access control method according to claim 7, wherein the first determining includes determining, when the associated basic permission attribute is allowed concerning at least one of the items of access control information associated with the basic permission attribute, that the basic permission attribute is allowed and, when the basic permission attribute is denied concerning all the items of access control information, that the basic permission attribute is denied.

9. The access control method according to claim 7, wherein the access-control-information storing unit stores the access control information in an extended attribute area of an inode in which information concerning the respective objects on the file system is stored.

10. A computer program product having a computer readable medium including programmed instructions for receiving an access request to a file system from a user terminal through a common Internet file system (CIFS) or a network file system (NFS) and for determining whether the access request should be allowed, wherein the instructions, when executed by a computer, cause the computer to perform:
issuing, when a file creation request is received from a user terminal through the CIFS, before issuing a system call for performing file creation in response to the file creation request, access control information for the file indicating whether an access request is allowed concerning respective objects of the file system through an I/O control different from the system call;
executing storing processing for storing access control information issued through the I/O control in an extended attribute area of an inode on the file system in each of sessions of journals identical with respective journals for respective kinds of metadata update processing carried out in the file system; and
determining, when an access request is received from the user terminal through the CIFS, whether the access request is allowed, based on the access control information stored in the file system.

11. The computer program product according to claim 10, wherein the instructions further causes the computer to execute hooking, concerning a volume of the file system accessed from the user terminal through the CIFS, an interface concerning a root directory and metadata of the file system and hooking, in hooking an interface concerning a directory of a mount destination, an interface concerning a file right below the directory to sufficiently hook a file system interface concerning the mounted volume.

12. The computer program product according to claim 11, wherein the hooking includes, concerning a volume of the file system accessed from the user terminal through the CIFS, only when an identifier indicating that the volume is a hook object is added to a mount option included in a mount request for mounting the volume, determining that the volume is the hook object.

13. The computer program product according to claim 11, wherein the hooking includes counting a number of hooked volumes in a hook driver, and prohibiting unload of the driver while the count remains.

14. The computer program product according to claim 10, wherein the storing processing includes
when access control information is stored in an extended attribute area of an inode on the file system, in the I/O control, temporarily storing a context in a hook driver in a kernel together with the access control information;
in the system call, determining whether the context coincides with that of received correct access control information; and
on condition that the access control information is the received correct access control information, storing the access control information in the extended attribute area.

15. An access control apparatus, connected to a user terminal through a common Internet file system (CIFS) or a network file system (NFS), for receiving an access request to a file system from the user terminal and for determining whether the access request should be allowed, the access control apparatus comprising:
an access-control-information issuing unit that issues, when a file creation request is received from the user terminal connected through the CIFS, before issuing a system call for performing file creation in response to the file creation request, access control information for the directory indicating whether an access request is allowed concerning respective objects of the file system to an I/O control different from the system call and issues the access control information;
a storing processing unit that executes storing processing for storing the access control information issued through the I/O control by the access-control-information issuing unit in an extended attribute area of an inode on the file system in each of sessions of journals identical with respective journals for respective kinds of metadata update processing carried out in the file system; and
an access control unit that determines, when the access request is received from the user terminal connected by the CIFS, based on the access control information stored in the file system by the storing processing unit, whether the access request is allowed.

16. An access control method for receiving an access request to a file system from a user terminal through a common Internet file system (CIFS) or a network file system (NFS) and for determining whether the access request should be allowed, the access control method comprising:
issuing, when a file creation request is received from the user terminal through the CIFS, before issuing a system call for performing file creation in response to the file creation request, access control information for the directory indicating whether an access request is allowed concerning respective objects of the file system to an I/O control different from the system call, and issuing the access control information;
executing storing processing for storing the access control information issued through the I/O control in an extended attribute area of an inode on the file system in each of sessions of journals identical with respective journals for respective kinds of metadata update processing carried out in the file system; and
determining, when the access request is received from the user terminal through the CIFS, based on the access control information stored in the file system by the storing processing unit, whether the access request is allowed.
